(19) United States
(12) Patent Application Publication
(10) Pub. No.: US 2026/0199988 A1
(43) Pub. Date: Jul. 16, 2026

(54) TOOL HOLDER

(71) Applicant: PCM Precision Tooling SA, Vielleneuve VD (CH)

(72) Inventor: Stephan BERCHTOLD, Moosseedorf (CH)

(73) Assignee: PCM Precision Tooling SA, Vielleneuve VD (CH)

(21) Appl. No.: 19/446,317

(22) Filed: Jan. 12, 2026

(30) Foreign Application Priority Data
Jan. 13, 2025 (EP) 25151527.6

(51) Int. Cl. B23B 31/30

(52) U.S. Cl. CPC B23B 31/30

(57) ABSTRACT

A tool holder having a housing which is fastenable to a support unit of a machine tool. Rotatably mounted on the housing is a shaft which at the front end has a tool receptacle and at the rear end a drive connector which is drivable by a drive transmission of the support unit. The tool receptacle has at a contact region, on which the connector region of the tool to be clamped is able to rest, a pressurized chamber that is concentric with the shaft axis and is fillable with a pressurizing medium. The pressurized chamber is connected in the shaft to a pressure generator device via a pressurized medium connection. The pressure generator device is disposed in a front end region of the shaft. The tool holder is of a simple construction and is particularly suitable for clamping driven tools which are infrequently changed.

### CROSS-REFERENCE TO RELATED APPLICATIONS

This application claims priority from European Patent Application no. 25151527.6, filed January 13, 2025, which is incorporated herein by reference as if fully set forth.

### TECHNICAL FIELD

The invention relates to a tool holder.

### BACKGROUND

Tool holders with a housing and a shaft which is rotatably mounted on the latter enable tools to be held, said tools rotating during the machining of workpieces. The tool holders with guided rotating tools are referred to as driven tools and using this description are distinguished from tools that are fixedly disposed on the tool holder and only guided by the tool holder. In terms of the tool rotation axis, driven tools can be used for axial and radial machining operations and combinations thereof.

Driven tools are used, for example, in lathes for complete machining operations such that, apart from turning, also milling, boring or other machining operations are made possible. Customary driven tools are tool holders with a milling cutter, hob cutter, thread milling cutter, gear cutter, drill head, countersink, thread cutter, a reamer or potentially also a circular saw disposed rotatably thereon. Machine tools with rotating or fixedly held workpieces and with guided fixed and driven tools enable complete machining of workpieces. Lathes with fixed and driven guided tools can produce products with various shapes when proceeding from bar stock material without re-clamping the workpiece.

In the known driven tools, the connection between the tool holder and the tool is formed by a collet chuck, in particular by an ER collet chuck. On the front end of the shaft, which is rotatably mounted on the housing, i.e. the end assigned to the tool, the tool holder comprises a frustoconical or conical receptacle opening or collet chuck receptacle and, in the latter, a radially slotted sleeve or a collet chuck having a frustoconical or conical external shape and a central bore for receiving a tool shank. In the technical field, a truncated cone is often referred to as a cone, or as conical, respectively. For clamping a tool inserted in the central bore, the collet chuck is pressed into the collet chuck receptacle by a union nut which is able to be screwed onto an external thread of the shaft, wherein the central bore is constricted, and the shank of the tool is held in a force-fitting manner in the collet chuck and the collet chuck is held in a force-fitting manner in the shaft.

For positioning and guiding fixed and driven tools, the machine tools comprise drum-shaped and/or column-like support units with receptacles for the tool holders. The support units, with the tool holders disposed thereon, are movable relative to the workpiece to be machined. There are also support units in which the tool holder is positioned by cylindrical pins.

In long center lathes, the bar-shaped material to be machined is clamped in the lathe spindle and guided in a guide bushing. When machining the bar-shaped material, the latter is positioned in such a way that the machining by tools takes place as close as possible to the guide bushing. As a result, the bar-shaped material is optimally protected against deformation, in particular flexing, during the entire machining process. For applications of great complexity, besides the fixed tools for turning, drivable tools with respective axes for machining the non-rotating bar-shaped material or workpiece are also used.

Long center lathes are used, for example, for producing small metallic parts, also referred to as bar turning. Such small parts are produced, for example, for the watch or medical industry and for microtechnology and micromechanics. The guided rotating tools used in the production of small parts have in most instances small diameters transverse to the tool axis, and the connection between the tool holder and the tool has to be correspondingly designed to be small and precise. Forming the collet chuck receptacle, the collet chuck, the external thread of the shaft and the internal thread of the union nut in a small and precise manner is extremely complex.

DE 10 2004 044187 A1 describes a machining center with a turret head on which are disposed tool holders for drivable tools in assembly bores. Each tool holder comprises a housing in which a shaft is rotatably mounted by way of two mutually spaced-apart rotary bearings. Located on the shaft between the two rotary bearings is a rotor, and located on the housing is a stator of a drive motor.

On the front end of the shaft assigned to the tool, the shaft has a frustoconical or conical collet chuck receptacle. This collect chuck receptacle receives the collet chuck which, conjointly with a union nut, enables the shank of a tool to be fixedly held in force-fitting manner in the collet chuck and the collet chuck to be fixedly held in a force-fitting manner on the shaft.

The known tool holders are complex in terms of construction and complex machining steps are necessary for producing them. The complex construction is conceived in such a way that the tools clamped therein can be frequently changed with little complexity and with little wear on the collect chuck and on the tools used.

In machine tools with support units for many driven tools, individual tools may remain in the tool holder for a very long time. When driven tools are infrequently changed on the tool holder due to their infrequent use or due to their high quality, the high complexity in terms of the production of the known tool holders cannot be justified.

### SUMMARY

The object according to the invention now lies in finding a tool holder for driven tools which is of a simple construction for tools that are infrequently changed.

This object is achieved by a tool holder having one or more of the features disclosed herein. Advantageous variants of embodiment which achieve further objects are described in detail below and in the claims.

A tool holder according to the invention comprises a housing which has a positioning connector for positioning on a support unit of a machine tool, and a shaft which extends along a shaft axis. At a front end of the shaft, the tool holder comprises a tool receptacle for clamping the connector region of a tool. The shaft is mounted on the housing so as to be rotatable about the shaft axis by a rotary mounting. The rotary mounting of the shaft comprises a front and a rear rotary bearing, of which the front rotary bearing lies closer to a front end of the shaft than the rear rotary bearing. The shaft at a rear end, which faces away from the front end, has a drive connector which is designed in such a way that the latter, after disposing the tool holder on the support unit, is able to be driven by a drive transmission of the support unit. The tool receptacle has at a contact region, on which the connector region of the tool to be clamped is able to rest, a pressurized chamber which is designed to be concentric with the shaft axis and is able to be filled with a pressurizing medium. The pressurized chamber is connected in the shaft to a pressure generator device by way of a pressurized medium connection. The pressure generator device is disposed in a region that extends from the front end of the shaft up to the front rotary bearing. When the connector region of the tool is contiguous to the contact region and when a pressure has been built up in the pressurized chamber between the contact region and the connector region of the tool by the pressure generator device, the pressurized chamber, due to a deformation of the contact region against the connector region, enables a force-fitting connection to be achieved.

Preferably oil, or optionally grease, is used as the pressurized medium.

Forming the pressurized chamber, which is disposed at a contact region and is able to be filled with a pressurized medium, the pressurized medium connection and the pressure generator device according to the invention is substantially less complex than producing the parts which are required for the tool holders known in the prior art, specifically the frustoconical collet chuck receptacle, the ER collet chuck, the union nut and the threads required for clamping. Apart from the less complex production, the solution according to the invention also has the advantage of a shorter construction length, because the pressure generator device is disposed in a region which extends from the front end of the shaft up to the front rotary bearing. In the case of tool holders with collet chucks, the union nut projects beyond the shaft.

In one advantageous embodiment, the pressurized chamber has at least two pressurized chamber regions which are designed to be concentric with the shaft axis and which are disposed so as to be mutually spaced apart in the direction of the shaft axis. The pressurized chamber regions, when a pressure has been built up in the pressurized chamber between the contact region and the connector region of the tool by the pressure generator device, due to deformations of the contact region at the at least two pressurized chamber regions against the connector region, enable a force-fitting connection to be achieved. Optionally, instead of one pressurized chamber with at least two pressurized chamber regions, at least two pressurized chambers that enable the desired deformations of the contact region to be achieved are provided.

According to a preferred embodiment, the pressure generator device has in the shaft a pressure generator bore with a thread and a pressure bolt which is able to be screwed into the latter. The pressurized medium filled into the pressurized chamber and the pressurized medium connection, due to the pressure bolt being screwed in, enable the pressure in the pressurized chamber required for the force-fitting connection to be achieved. In an embodiment with more than one pressurized chamber, the pressurized chambers can be connected to a common pressure generator device, or optionally be in each case connected to a dedicated pressure generator device.

In order that the pressurized medium cannot escape at the pressure bolt, the pressure generator device of a particularly advantageous embodiment comprises at the end of the pressure bolt that faces the pressure medium connection, in a thread-free region of the pressure generator bore, a sealing piston. Optionally, a compression piston is disposed between the pressure bolt and the sealing piston.

In a further preferred embodiment, the pressurized chamber is connected to a closable ventilation device by way of a ventilation connection formed in the shaft, wherein the closable ventilation device is disposed in a region which extends from the front end of the shaft up to the front rotary bearing.

An advantageous ventilation device has in the shaft a ventilation bore with a thread and a ventilation bolt which is able to be screwed into this ventilation bore with a thread. After filling the pressurized medium, air or pressurized fluid can exit by way of an exit channel of the ventilation bolt when screwing in the ventilation bolt. When the screwed-in ventilation bolt by way of a sealing region of its leading end rests on a constriction of the ventilation bore, the ventilation bore is closed, and only pressurized medium is contained in the pressurized chamber, in the pressurized medium connection and in the ventilation connection, so that the pressure required for the force-fitting connection is able to be achieved by the pressure generator device without interference due to compressible residual air.

In one preferred embodiment, the axes of the ventilation device, of the ventilation connection and of the pressurized medium connection extend along a common straight line, the latter in particular intersecting the shaft axis. When filling the pressurized medium by way of the pressurized medium connection, the shaft can be aligned in such a way that the pressurized medium fills the pressurized medium connection, the pressurized chamber and the ventilation connection so as to ascend therein.

In a further advantageous embodiment, the axis of the bore of the pressure generator device extends tangentially to a circle about the shaft axis, such that this bore can extend over a longer length in the shaft as compared to a radial bore.

The access entrances to the pressure generation bore and to the ventilation bore are preferably disposed in such a way that both access entrances lie above the pressurized chamber in a suitable position of the shaft. After complete filling with the pressurized medium, the pressure bolt, preferably with the sealing piston, and in particular with the compression piston, is introduced into the pressure generator bore while the access to the pressure generator bore is directed upwards. The ventilation bolt is subsequently screwed in.

In a particularly preferred embodiment, the tool receptacle has at the contact region in the shaft a cylindrical hole formed concentrically with the shaft axis, and in said cylindrical hole a cylindrical contact surface facing the shaft axis. This embodiment is conceived for receiving a connector region of the tool in the form of a cylindrical shank, wherein the opening surrounded by the contact surface has a diameter which is adapted to the diameter of a tool shank to be inserted, such that the tool shank is just able to be introduced into the opening surrounded by the contact surface and, when a pressure is built up in the pressurized chamber between the contact region and the connector region of the tool by the pressure generator device, due to a deformation of the contact region against the tool shank, a force-fitting connection is able to be achieved.

In another embodiment, the tool receptacle has at the contact region a cylindrical end region formed concentrically with the shaft axis, and on said cylindrical end region a cylindrical contact surface facing away from the shaft axis. This embodiment is conceived for receiving a connector region of the tool in the form of a cylindrical bore, wherein the cylindrical contact surface facing away from the shaft axis has a diameter which is adapted to the diameter of the cylindrical bore of the tool to be inserted such that the tool is able to be pushed over the cylindrical portion formed by the contact surface and, when a pressure is built up in the pressurized chamber between the contact region and the connector region of the tool by the pressure generator device, due to a deformation of the contact region against the cylindrical bore of the inserted tool, a force-fitting connection is able to be achieved.

In advantageous embodiments, the contact surface is formed on a sleeve which is connected to the shaft. The sleeve borders the pressurized chamber towards the connector region of the tool to be clamped and at its frontal ends is tightly connected to the shaft. In particular, the pressurized chamber is formed as a recess in the sleeve, which is disposed so as to face away from the contact surface.

In an embodiment with at least two pressurized chamber regions, a separation is formed between the at least two pressurized chamber regions, said separation being able to be formed, for example, by a web of the shaft, or by a region of the sleeve without a recess or with a recess of lesser depth. The separation guarantees that the sleeve is deformed to a lesser extent at this location when impinged with pressure, or that the sleeve is deformed to a greater extent at the pressurized chamber regions. A more severe deformation in at least two mutually spaced apart regions increases the precision of alignment of an inserted tool.

An advantageous tool holder comprises an adapter which adjoins the contact region and which is adapted to a connector region of the tool that deviates from the contact region. When the adapter is inserted between the contact region of the tool holder and the connector region of the tool, a pressure built up in the pressurized chamber by the pressure generator device enables a deformation of the adapter against the connector region of the tool to be clamped to be achieved, and by way of this deformation enables a force-fitting connection between the contact region and the connector region of the tool to be clamped to be achieved by way of the adapter.

According to a further advantageous embodiment, the positioning connector for positioning on a support unit of a machine tool comprises at least one connector surface which for positioning the tool holder is able to rest on a positioning surface of the support unit. The connector surface can be formed by a region of the housing, in particular by a cylindrical external surface of the housing, which region is able to rest so as to match a positioning surface, in particular a cylindrical internal surface, of the support unit. For example, the connector surface can also be formed as an internal surface of a bore or as an external surface of a bolt, wherein the bore or the bolt is formed on the positioning connector, and the support unit correspondingly has a bolt or a bore as a positioning surface.

When the positioning connector by way of the connector surface is positioned on a positioning surface of the support unit, the tool holder, in particular the positioning connector, is fastened to the support unit by way of a connection element. In order to achieve the retaining force between the interconnected parts, the tool holder comprises an engagement region for the connection element, wherein the connection element when engaging with the engagement region enables a retaining force between the tool holder and the support unit to be achieved. When the connection element is a bolt, the engagement region is preferably a bore, optionally having an internal thread. The bolt, by way of the bolt head, can rest on the opening of the bore and be screwed into a thread of the support unit. Optionally, the bolt head rests on a bore of the support unit and is screwed into a thread of the tool holder.

The tool holder and the support unit are preferably designed in such a way that the drive connector at the rear end of the shaft of a tool holder fastened to the support unit engages in a form-fitting manner in a drive transmission of the support unit. In an advantageous embodiment, the drive connector of the tool holder is designed as a gearwheel which, after fastening the tool holder to the support unit, engages in a drivable gearwheel of the support unit.

### BRIEF DESCRIPTION OF THE DRAWINGS

The drawings explain the invention by means of two exemplary embodiments without however being limited thereto. In the drawings

FIG. 1 shows a perspective illustration of a tool holder with a tool clamped in the interior of a cylindrical contact surface,

FIGS. 2 to 4 show perspective illustrations of the tool holder according to FIG. 1 with regions shown in sectional views,

FIG. 5 shows a frontal view of the tool holder according to FIG. 1 with a region shown in a sectional view,

FIG. 6 shows a perspective illustration of a tool holder with a tool clamped on the external side of a cylindrical contact surface,

FIG. 7 shows a perspective illustration of the front side of a support unit with inserted tool holders, and

FIG. 8 shows a perspective illustration of the rear side of a support unit with tool holders.

### DETAILED DESCRIPTION

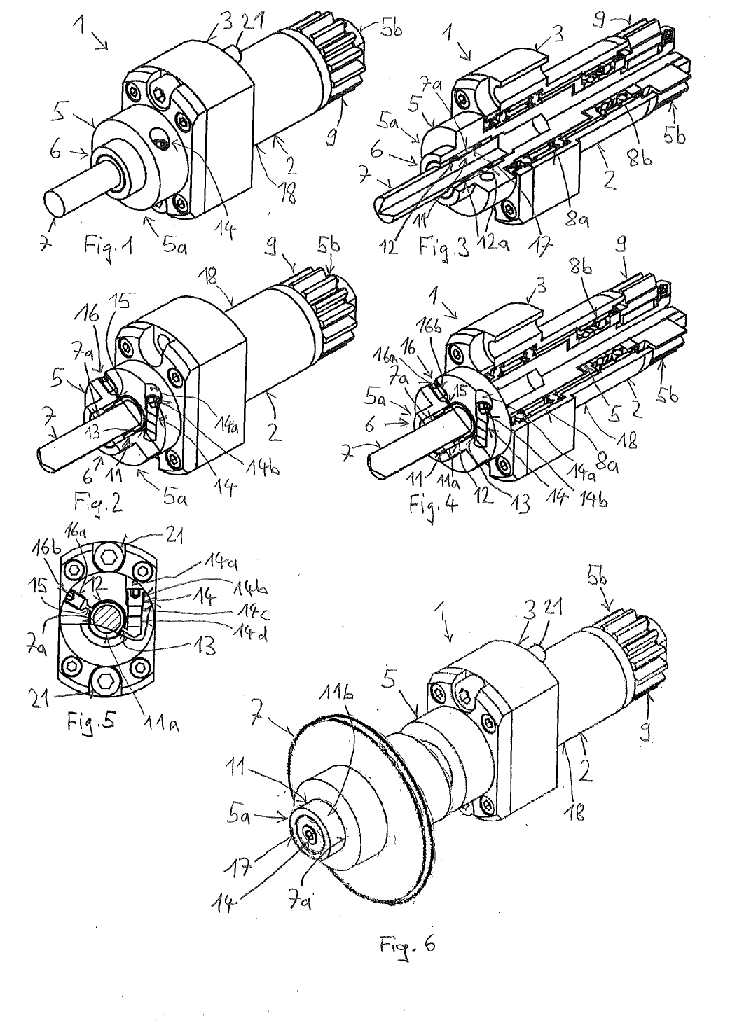

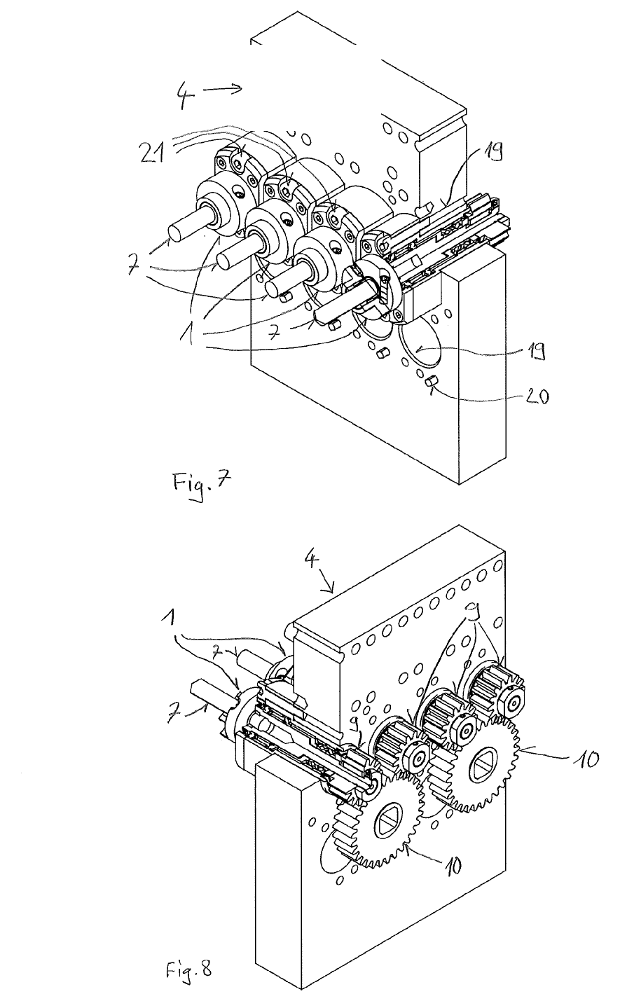

FIGS. 1 to 5 show a tool holder 1 according to the invention with a housing 2 which has a positioning connector 3 for positioning on a support unit 4 of a machine tool, illustrated in FIGS. 7 and 8. The tool holder 1 comprises a shaft 5 which extends along a shaft axis. At a front end 5a of the shaft 5, the tool holder 1 comprises a tool receptacle 6 for clamping the connector region of a tool 7.

The shaft 5 is mounted on the housing 2 so as to be rotatable about the shaft axis by a rotary mounting. The rotary mounting of the shaft 5 comprises a front rotary bearing 8a and a rear rotary bearing 8b, of which the front rotary bearing 8a lies closer to the front end 5a of the shaft 5 than the rear rotary bearing 8b. The shaft 5 has at a rear end 5b, which faces away from the front end 5a, a drive connector 9, preferably in the form of a gearwheel. As illustrated in FIG. 8, the drive connector 9, or the gearwheel, on the rear end 5b of the shaft 5 is designed in such a way that the drive connector 9, or the gearwheel, after disposing the tool holder 1 on the support unit 4, is able to be driven by a drive transmission 10, in particular by a driven gearwheel, of the support unit 4.

The tool receptacle 1 has at the contact region 11, on which the connector region 7a of the tool 7 to be clamped is able to rest, a pressurized chamber 12 with two pressurized chamber regions 12a which are designed so as to be concentric with the shaft axis and are able to be filled with a pressurized medium. The pressurized chamber regions 12a are disposed so as to be mutually spaced apart in the direction of the shaft axis and are in the shaft 5 connected to a pressure generator device 14 by way of a pressurized medium connection 13. The pressure generator device 14 is disposed in a region that extends from the front and 5a of the shaft 5 up to the front rotary bearing 8a.

In the embodiment illustrated, the pressure generator device 14 comprises in the shaft 5 a pressure generator bore 14a with a thread, and a pressure bolt 14b which is able to be screwed into this pressure generator bore 14a. In order that the pressurized medium cannot escape at the pressure bolt 14b, the pressure generator device 14 comprises, preferably at the end of the pressure bolt 14b that faces the pressurized medium connection 13, in a thread-free region of the pressure generator bore 14a a compression piston 14c and a sealing piston 14d. The pressurized medium which is filled into the pressurized chamber regions 12a and into the pressurized medium connection 13, by screwing-in the compression bolt 14b, enables the pressure in the pressure chamber regions 12a required for the force-fitting connection to be achieved.

In the embodiment illustrated, the pressurized chamber regions 12a are connected to a closable ventilation device 16 by way of a ventilation connection 15 formed in the shaft 5, wherein the closable ventilation device 16 is disposed in a region which extends from the front end 5a of the shaft 5 up to the front rotary bearing 8a. The ventilation device 16 has in the shaft 5 a ventilation bore 16a with a thread and a ventilation bolt 16b which is able to be screwed into this ventilation bore 16a. After filling the pressurized medium, air or pressurized fluid can exit by way of an exit channel of the ventilation bolt 16b when screwing-in the ventilation bolt 16b. When the screwed-in ventilation bolt 16b by way of a sealing region of its leading end rests on a constriction of the ventilation bore 16a, the ventilation bore 16a is closed and only pressurized medium is contained in the pressurized chamber regions 12a, in the pressurized medium connection 13 and in the ventilation connection 15, such that the pressure required for the force-fitting connection is able to be achieved by the pressure generator device 14 without interference.

In the embodiment illustrated, the axes of the ventilation device 16, of the ventilation connection 15 and of the pressurized medium connection 13 extend along a common straight line that intersects the shaft axis. When filling the pressurized medium by way of the pressurized medium connection, the shaft 5 can be aligned in such a way that the pressurized medium fills the pressurized medium connection 13, the pressurized chamber regions 12a and the ventilation connection 15 so as to ascend therein.

The axis of the pressure generator bore 14a extends tangentially to a circle about the shaft axis, such that this bore can extend over a larger length in the shaft 5 in comparison to a radial bore. The access entrances to the pressure generator bore 14a and to the ventilation bore 16a are preferably disposed in such a way that both access entrances lie above the pressurized chamber regions 12a in a suitable position of the shaft. After complete filling with the pressurized medium, the pressure bolt 14b with the sealing piston 14d and the compression piston 14c is introduced into the pressure generator bore 14a while the access to the pressure generator bore 14a is directed upwards. The ventilation bolt 14b is subsequently screwed in.

When the connector region 7a of the tool 7 is contiguous to the contact region 11, and when the pressure in the pressurized chamber regions 12a is built up between the contact region 11 and the connector region 7a of the tool 7 by the pressure generator device 14, due to deformations of the contact region 11 against the connector region 7a, the pressurized chamber regions 12a achieve a force-fitting connection. Preferably oil, or optionally grease, is used as the pressurized medium.

The tool holder illustrated in FIGS. 1 to 5, 7 and 8 has at the contact region 11 in the shaft 5 a cylindrical hole 11a formed concentrically with the shaft axis, and in said cylindrical hole 11a a cylindrical contact surface facing the shaft axis. The cylindrical hole 11a, or the cylindrical contact surface formed by an internal surface, is conceived for receiving a connector region 7a of the tool 7 in the form of a cylindrical shank.

The tool holder 1 illustrated in FIG. 6 has at the contact region 11 a cylindrical end region 11b formed concentrically with the shaft axis, and on said cylindrical end region 11b a cylindrical contact surface facing away from the shaft axis. The cylindrical end region 11b, or the cylindrical contact surface formed by an external surface, is conceived for receiving a connector region 7a of the tool 7 in the form of a cylindrical passage, or a cylindrical bore, wherein the cylindrical contact surface facing away from the shaft axis has a diameter which is adapted to the diameter of the cylindrical bore of the tool 7 to be inserted such that the tool 7 is just able to be pushed over the cylindrical portion formed by the contact surface. When a pressure is built up in the pressurized chamber regions 12a by the pressure generator device 14, a force-fitting connection between the contact region 11 and the connector region 7a of the tool 7 is achieved due to deformations of the contact region 11 against the connector region 7a of the tool 7.

The tool schematically illustrated in FIG. 6 extends radially away from the connector region 7a, or from a tool connector which is annular in cross section, and is designed, for example, as a circular saw blade. The pressure generator device 14 is inserted at the end face of the cylindrical end region 11b. The ventilation device is disposed on the shaft 5, for example, between the tool connector and the positioning connector 3.

In both embodiments illustrated in FIGS. 1 to 8, the contact surface is formed on a sleeve 17 which is connected to the shaft 5. The sleeve 17 borders the pressurized chamber regions 12a towards the connector region 7a of the tool 7 to be clamped and is at its frontal ends tightly connected to the shaft 5. In particular, the pressurized chamber regions 12a are formed as recesses in the sleeve 17 that face away from the contact surface.

The positioning connector 3 comprises a portion of the housing 2, said portion serving as a connector surface 18 for positioning the tool holder 1 on a positioning surface 19 formed by a bore in the support unit 4. The connector surface 18 can also comprise the internal surface of a bore, the latter for positioning interacting with a bolt 20 of the support unit 4. A positioned tool holder 4 is fastened to the support unit 4 by way of two fastening screws 21, for example.

1. A tool holder (1), comprising:
a housing (2) which has a positioning connector (3) for positioning on a support unit (4) of a machine tool;
a shaft (5) which extends along a shaft axis and is mounted on the housing (2) by a rotary mounting so as to be rotatable about the shaft axis, the rotary mounting of the shaft (5) comprises a front rotary bearing (8a) and a rear rotary bearing (8b), of which the front rotary bearing (8a) lies closer to a front end (5a) of the shaft (5) than the rear rotary bearing (8b), and a tool receptacle (6), which is disposed at the front end (5a) of the shaft (5), that is adapted for clamping a connector region (7a) of a tool (7);
a drive connector (9) at a rear end (5b) of the shaft (5), which faces away from the front end (5a), the drive connector (9) is adapted, after disposing the tool holder (1) on the support unit (4), to be driven by a drive transmission (10) of the support unit (4);
the tool receptacle (6) has a pressurized chamber (12) at a contact region (11), on which the connector region (7a) of the tool (7) to be clamped is able to rest;
the pressurized chamber (12) is concentric with the shaft axis and is adapted to be filled with a pressurizing medium and the pressurized chamber (12) is connected in the shaft (5) to a pressure generator device (14) by way of a pressurized medium connection (13), the pressure generator device (14) is disposed in a region of the shaft (5) that extends from the front end (5a) of the shaft (5) up to the front rotary bearing (8a) and, when the connector region (7a) of the tool (7) is contiguous to the contact region (11) and a pressure is built up in the pressurized chamber(12) by the pressure generator device (14) then the pressurized chamber (12) enables a force fitting connection between the contact region (11) and the connector region (7a) of the tool (7) due to deformation of the contact region (11) against the connector region (7a).

2. The tool holder (1) according to claim 1, wherein the pressurized chamber (12) has at least two pressurized chamber regions (12a) which are concentric with the shaft axis and are disposed so as to be mutually spaced apart in a direction of the shaft axis and, upon the pressure being built up in the pressurized chamber (12) by the pressure generator device (14), the pressurized chamber (12) enables a force-fitting connection between the contact region (11) and the connector region (7a) of the tool (7), due to deformations of the contact region (11) at the at least two pressurized chamber regions (12a) against the connector region (7a).

3. The tool holder (1) according to claim 1, wherein the pressure generator device (14) has in the shaft (5) a pressure generator bore (14a) with a thread, and a pressure bolt (14b) that is adapted to be screwed into the thread, such that a pressurized medium filled into the pressurized chamber (12) and the pressurized medium connection (13), due to the pressure bolt (14b) being screwed in, generates the pressure in the pressurized chamber (12) required for the force-fitting connection to be achieved.

4. The tool holder (1) according to claim 1, wherein the pressurized chamber (12) is connected to a closable ventilation device (16) via a ventilation connection (15) formed in the shaft (5), and the closable ventilation device (16) is disposed in a region which extends from the front end (5a) of the shaft (5) up to the front rotary bearing (8a).

5. The tool holder (1) according to claim 4, wherein the ventilation device (16) has in the shaft (5) a ventilation bore (16a) with a thread and a ventilation bolt (16b) which is able to be screwed into the thread, and after filling the pressurized medium, air or pressurized medium is able exit to the ventilation connection (15) by screwing-in the ventilation bolt (16b) such that after completely screwing-in the ventilation bolt (16b) only pressurized medium is contained in the pressurized medium connection (13), in the pressurized chamber (12) and in the ventilation connection (15), and the pressure required for the force-fitting connection is able to be achieved by the pressure generator device (14).

6. The tool holder (1) according to claim 1, wherein the tool receptacle (6) has at the contact region (11) in the shaft (5) a cylindrical hole (11a) formed concentrically with the shaft axis, and in said cylindrical hole (11a) a cylindrical contact surface facing the shaft axis.

7. The tool holder (1) according to claim 6, wherein the contact surface is formed on a sleeve (17), and the sleeve (17) borders the pressure chamber (12) against the connector region (7a) of the tool (7) to be clamped and is tightly connected to the shaft (5) at its front ends.

8. The tool holder (1) according to claim 7, wherein the pressurized chamber (12) is formed as a recess in the sleeve (17).

9. The tool holder (1) according to claim 1, wherein the tool receptacle (6) has at the contact region (11) a cylindrical end region (11b) formed concentrically with the shaft axis, and on said cylindrical end region (11b) a cylindrical contact surface facing away from the shaft axis.

10. The tool holder (1) according to claim 9, wherein the contact surface is formed on a sleeve (17), and the sleeve (17) borders the pressurized chamber (12) towards the connector region (7a) of the tool (7) to be clamped and is tightly connected to the shaft (5) at a front end thereof.

11. The tool holder (1) according to claim 10, wherein the pressurized chamber (12) is formed as a recess in the sleeve (17).

12. The tool holder (1) according to claim 1, further comprising an adapter that adjoins the contact region (11) and on which the connector region (7a) of the tool (7) to be clamped is able to rest, and a pressure built up in the pressurized chamber (12) by the pressure generator device (14) enables a deformation of the adapter against the connector region (7a) of the tool (7) to be clamped to be achieved, and by way of the deformation of the adapter enables a force-fitting connection between the contact region (11) and the connector region (7a) of the tool (7) to be clamped to be achieved by way of the adapter.

13. The tool holder (1) according claim 1, wherein the positioning connector (2) comprises at least one connector face (18) which for positioning the tool holder (1) is adapted to rest on a positioning face (19) of the support unit (4).

14. The tool holder (1) according to claim 13, further comprising an engagement region for a connection element (21), and the connection element (21) when engaging with the engagement region enables a retaining force between the tool holder (1) and the support unit (4) to be achieved.
